(19) United States
(12) Patent Application Publication
(10) Pub. No.: US 2026/0336526 A1
(43) Pub. Date: Oct. 29, 2026

(54) FASTENER, FASTENING STRUCTURE, AND VEHICLE INTERIOR ACCESSORY

(71) Applicant: NIFCO INC., Yokosuka-shi, Kanagawa (JP)

(72) Inventor: Daisuke SATO, Yokosuka-shi, Kanagawa (JP)

(21) Appl. No.: 19/106,208

(22) PCT Filed: Aug. 3, 2023
(86) PCT No.: PCT/JP2023/028411

§ 371 Date: Feb. 25, 2025

(30) Foreign Application Priority Data
Sep. 15, 2022 (JP) 2022-146755

(51) Int. Cl. B60R 7/08; F16B 35/06

(52) U.S. Cl. CPC B60R 7/08; F16B 35/06

(57) ABSTRACT

A fastener allows introduction of a trunk portion into a receiving portion defined in the fastened target through elastic deformation of an elastic arm portion which is a portion of the trunk portion toward a center of the trunk portion and is fastened to the fastened target by causing a portion of the clastic arm portion to enter an engagement hole defined in a side wall of the receiving portion through elastic return of the elastic arm portion in a completion position of the introduction. The elastic arm portion is formed along a direction circling around a central axis of the trunk portion, and an engagement protruding portion engaging with the engagement hole is formed between a base portion and a free end of the elastic arm portion.

### FIELD

The present invention relates to a fastener that allows introduction into a receiving portion defined in a fastened target through elastic deformation and has a configuration so as to be fastened to the fastened target through elastic return in a completion position of the introduction, a fastening structure including this, and a vehicle interior accessory using these.

### BACKGROUND

Patent Literature 1 below discloses an article that is composed of a grommet and a pin, that allows introduction of a leg part of the pin into the grommet through elastic deformation of a catch disposed on the leg part, in which the pin is fastened to the grommet by causing the catch to enter an open part of the grommet through elastic return of the catch in a completion position of the introduction.

In the article in Patent Literature 1, the catch is formed along the central axis of the pin and includes a base portion in a direction toward a tip of the pin, and a free end is located in a direction toward a head portion of the pin.

In the article in Patent Literature 1, if the pin is rotated from a state where the pin is fastened to the grommet, a side portion of the catch comes into contact with an opening edge of the open part, and the catch elastically deforms inward to come out of the open part, whereby the fastened state of the pin and the grommet is released.

### CITATION LIST

### Patent Literature

Patent Literature 1: Japanese U.S. Pat. No. 4,375,695

### SUMMARY

### Technical Problem

In the article in Patent Literature 1 above, the fastened state of the pin and the grommet is improved by making a large setting of force necessary to remove the pin from the grommet, Unfortunately, in the article in Patent Literature 1, as a larger setting of the force necessary for the removal is made, resistance in operation of rotating the pin to release the fastening increases.

A main problem to be solved by the present invention is that, in a fastener of this type, a fastening structure including this, and a vehicle interior accessory using these, even if a large setting of force necessary to remove the fastener from a receiving portion of a fastened target is made, force necessary to release engagement with the fastened target through operation of rotating the fastener becomes not excessive.

### Solution to Problem

To solve the above-described problem, according to the present invention, in a first viewpoint, a fastener includes a head portion disposed at one end, a trunk portion connected to the head portion, and an elastic arm portion which is a portion of the trunk portion. The fastener allows introduction of the trunk portion into a receiving portion defined in a fastened target through elastic deformation of the elastic arm portion toward a center of the trunk portion and is fastened to the fastened target by causing a portion of the elastic arm portion to enter an engagement hole defined in a side wall of the receiving portion through elastic return of the elastic arm portion in a completion position of the introduction, wherein
the elastic arm portion is formed along a direction circling around a central axis of the trunk portion, and an engagement protruding portion engaging with the engagement hole is formed between a base portion and a free end of the elastic arm portion.

The elastic arm portion is formed along the direction circling around the central axis of the trunk portion, so that if the fastener is subjected to force in a direction of removing the trunk portion from the receiving portion in a state where the fastener is fastened to the fastened target, the elastic arm portion is difficult to deform in a direction toward the central axis, and the engagement protruding portion is caught on the engagement hole, preventing removal of the fastener.

On the other hand, if the fastener is subjected to torque causing rotation in a direction toward the base portion of the elastic arm portion with the central axis as the center from the state where the fastener is fastened to the fastened target, the engagement protruding portion and a hole edge of the engagement hole come into sliding contact with each other, facilitating elastic deformation of the elastic arm portion in the direction toward the central axis. This enables the state where the fastener is fastened to the fastened target to be readily released through rotation operation with the base portion side of the elastic arm portion composing the fastener as the forward side of the rotation.

According to one aspect of the present invention, two or more of the elastic arm portions are formed on the trunk portion at intervals in the direction circling around the central axis and the two or more of elastic arm portions are formed in such a manner that the free end of one of the elastic arm portions adjacent in the circling direction adjoins the base portion of the other of the adjacent elastic arm portions.

According to one aspect of the present invention, the trunk portion is provided with a restraining portion preventing elastic deformation of the elastic arm portion by coming into contact with the elastic arm portion when force in the direction of removing the trunk portion from the receiving portion is applied.

According to one aspect of the present invention, the trunk portion includes a bottom portion, the elastic arm portion being located between the bottom portion and the head portion, and the bottom portion is provided with the restraining portion.

According to one aspect of the present invention, the engagement protruding portion includes a side inclining surface decreasing a height of the engagement protruding portion gradually toward the base portion of the elastic arm portion.

According to one aspect of the present invention, the engagement protruding portion includes a lower inclining surface decreasing a height of the engagement protruding portion gradually from the head portion.

According to one aspect of the present invention, a passing hole for a string-like body is further included, the passing hole extending across the head portion and the trunk portion.

According to one aspect of the present invention, a pinch portion is further included on the head portion.

To solve the above-described problem, according to the present invention, in a second viewpoint, a fastening structure includes
the fastener, and the fastened target including the receiving portion for the trunk portion of the fastener, and
an inside diameter of the receiving portion decreases gradually toward a deep portion of the receiving portion.

To solve the above-described problem, according to the present invention, in a third viewpoint, a vehicle interior accessory includes
the fastener, and the fastened target including the receiving portion for the trunk portion of the fastener, and
the fastened target is a tubular body including the engagement hole in a tube side portion between one tube end which is an entrance of the receiving portion and is open and the other tube end.

### Advantageous Effects of Invention

According to the present invention, even if a large setting of force necessary to remove the fastener from the receiving portion of the fastened target is made, force necessary to release engagement with the fastened target through operation of rotating the fastener does not become excessive. Furthermore, according to the present invention, while the fastened state of the fastener is stabilized, operation of removal from the fastened target can be performed smoothly.

### BRIEF DESCRIPTION OF DRAWINGS

FIG. 1 is a perspective view of a fastener according to one embodiment of the present invention,

FIG. 2 is a perspective view of the fastener and illustrates the fastener viewed from a direction different from that in FIG. 1.

FIG. 3 is a plan view of the fastener.

FIG. 4 is a bottom view of the fastener,

FIG. 5 is a side view of the fastener.

FIG. 6 is a side view of the fastener and illustrates the fastener viewed from a direction different from that in FIG. 5.

FIG. 7 is a schematic sectional view taken along line VII-VII in FIG. 3.

FIG. 8 is a perspective view of a fastened target composing a fastening structure together with the fastener.

FIG. 9 is a plan view of the fastened target.

FIG. 10 is a side view of the fastened target.

FIG. 11 is a side view illustrating a state where the fastener is started to be introduced into the fastened target,

FIG. 12 is a schematic sectional view of a main portion in the state in FIG. 11.

FIG. 13 is a perspective view illustrating a state where the fastener is introduced, relative to the fastened target, into a completion position of the introduction.

FIG. 14 is a side view in the state in FIG. 13.

FIG. 15 is a schematic sectional view of the main portion in the state in FIG. 13.

FIG. 16 is a schematic sectional view of the main portion, illustrating a state where the fastener is subjected to force in a direction of removing the fastener from the fastened target from the state in FIG. 13.

FIG. 17 is a side view illustrating a state of operation of rotating the fastener in a direction of releasing engagement with the fastened target from the state in FIG. 13.

FIG. 18 is a plan view in the state in FIG. 17.

FIG. 19 is a schematic sectional view taken along line XIX-XIX in FIG. 18.

FIG. 20 is a schematic perspective view illustrating a state where the fastening structure is applied to a vehicle interior accessory.

### DESCRIPTION OF EMBODIMENTS

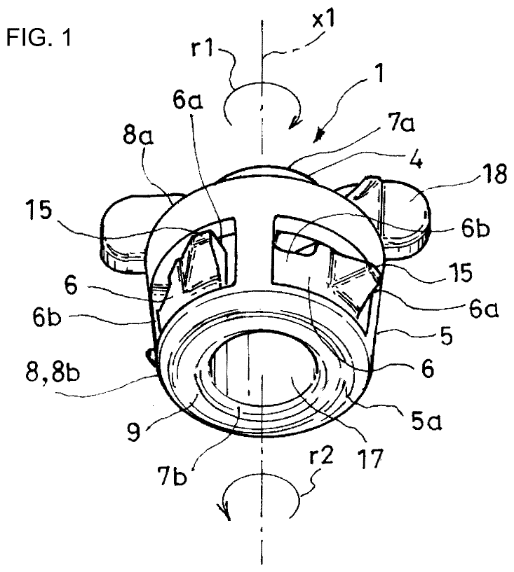

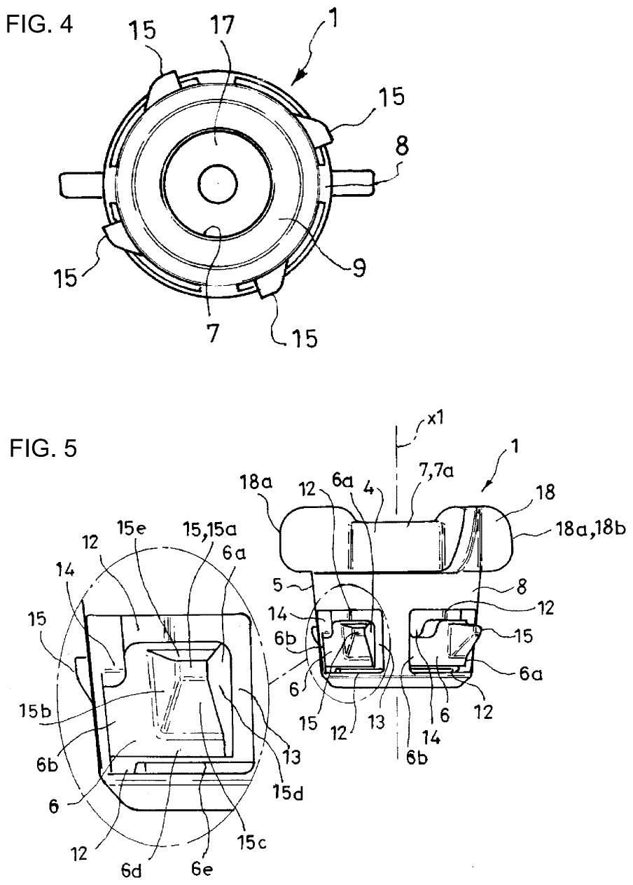

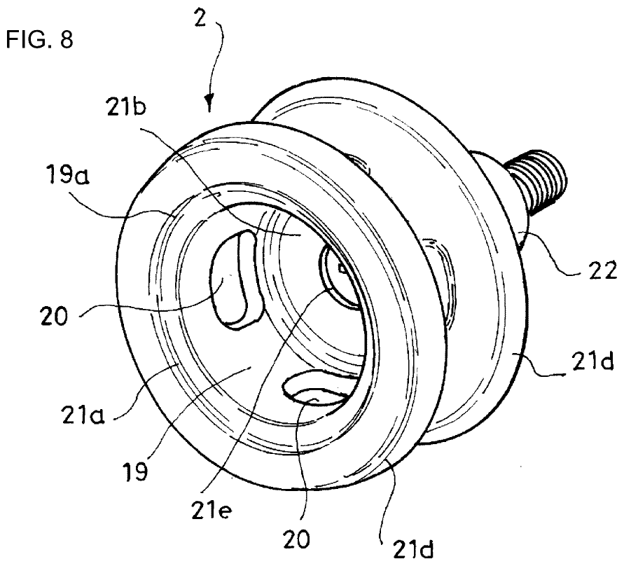

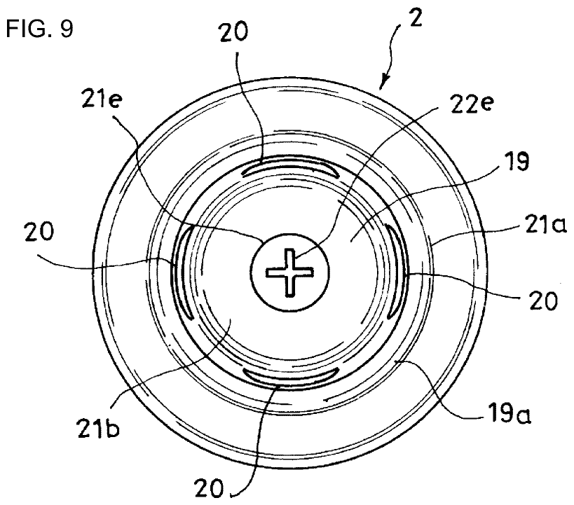

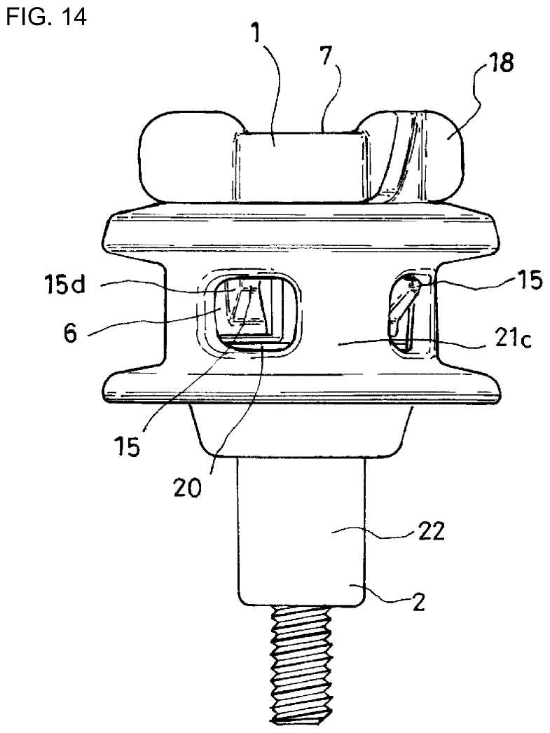

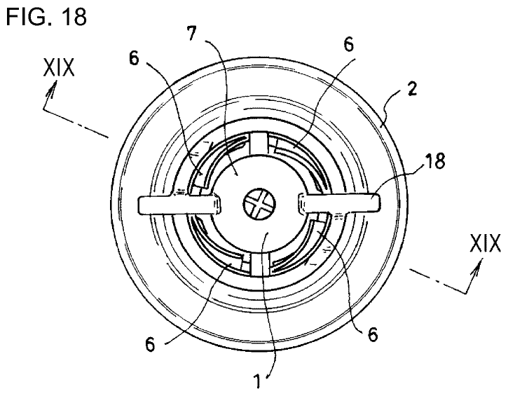

A typical embodiment of the present invention will be described below with reference to FIGS. 1 to 20.

A fastener 1 according to this embodiment that can be combined with a fastened target 2 includes a head portion 4 and a trunk portion 5, allows introduction of the trunk portion 5 into a receiving portion 19 defined in the fastened target 2 through elastic deformation of an elastic arm portion 6 which is a portion of the trunk portion 5 in a direction to the center (central axis x1, described later) of the trunk portion 5, and is fastened to the fastened target 2 by causing a portion of the elastic arm portion 6 to enter an engagement hole 20 defined in a side wall of the receiving portion 19 through elastic return of the elastic arm portion 6 in a completion position of the introduction.

An elastic deformation property can be readily provided to a portion that should have the elastic deformation property in this fastener 1 by making the fastener 1 as an article formed from plastic.

These fastener 1 and fastened target 2 compose a fastening structure using these.

Furthermore, these fastener 1 and fastened target 2 compose a vehicle interior accessory using these.

In this embodiment, the fastened target 2 is a tubular body 21 including one tube end 21a that serves as an entrance 19a of the receiving portion 19 and is open, the other tube end 21b that is closed, and a tube side portion 21c that is formed between the one tube end 21a and the other tube end 21b. In this embodiment, the interior of the tubular body 21 serves as the receiving portion 19, and the tube side portion 21c functions as the side wall of the receiving portion 19.

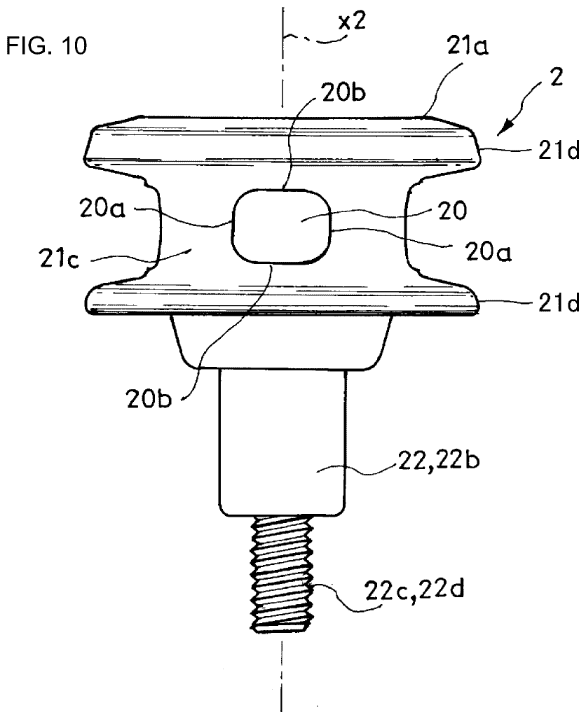

In the example illustrated in the drawings, on each of the one tube end 21a and the other tube end 21b of the tubular body 21, an outer flange 21d having a circular shape circling around a tube axis x2 (see FIG. 10) of the tubular body 21 is formed, In the tube side portion 21c between the outer flanges 21d in two places of the tubular body 21, the engagement hole 20 causing the interior and exterior of the tubular body 21 to communicate with each other is defined (see FIG. 10). In the example illustrated in the drawings, two or more engagement holes 20 are defined at intervals to the engagement holes 20 adjacent in a direction circling around the tube axis x2 of the tubular body 21, and, in the example illustrated in the drawings, four engagement holes 20 are defined at 90-degree intervals in the direction (see FIG. 9).

In the example illustrated in the drawings, each of the four engagement holes 20 is configured to have substantially the same dimensions and the same shape as the other engagement holes 20. In the example illustrated in the drawings, these engagement holes 20 have a substantially quadrilateral window shape. The engagement holes 20 are defined so as to include hole edges 20a along the tube axis x2 and hole edge 20b orthogonal to this tube axis x2.

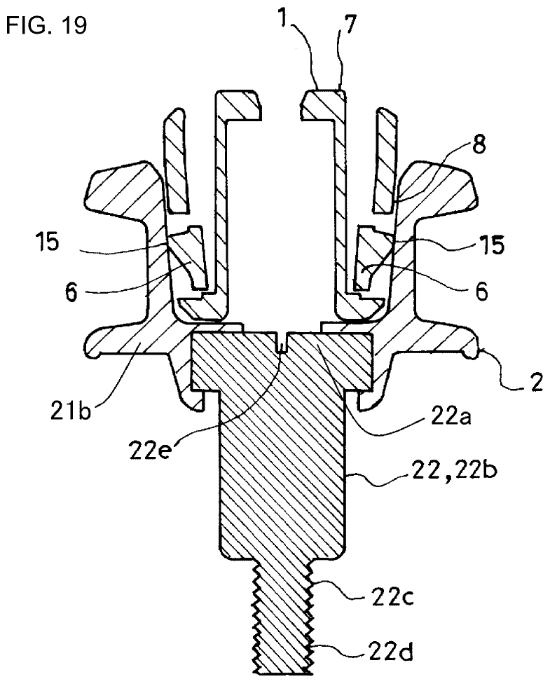

Furthermore, the inside diameter of the receiving portion 19 is configured to decrease gradually toward a deep portion of the receiving portion 19, in the example illustrated in the drawings, toward the other tube end 21b of the tubular body 21. In the example illustrated in the drawings, the interior and the exterior of the tube side portion 21c of the tubular body 21 have a form along an arc of an imaginary circle, and the inside diameter of this tube side portion 21c is wide on the one tube end 21a side and decreases gradually from that side toward the other tube end 21b (see FIG. 19).

The fastened target 2 is only required to include the receiving portion 19 described above and the engagement hole 20 in the side wall of the receiving portion 19, and its specific structure is modified appropriately as necessary, For example, the fastened target 2 may be a vehicle body side of a vehicle, such as a vehicle interior trim, and the like.

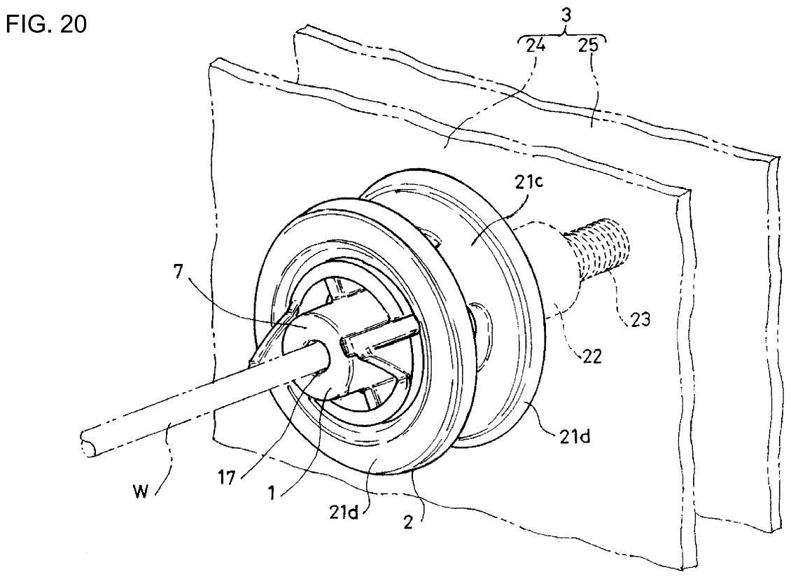

In the example illustrated in the drawings, the fastened target 2 further includes a shaft-like body 22 integrated with the tubular body 21 and is attached via this shaft-like body 22 to another target object 3, such as the vehicle body side of the vehicle (see FIG. 20).

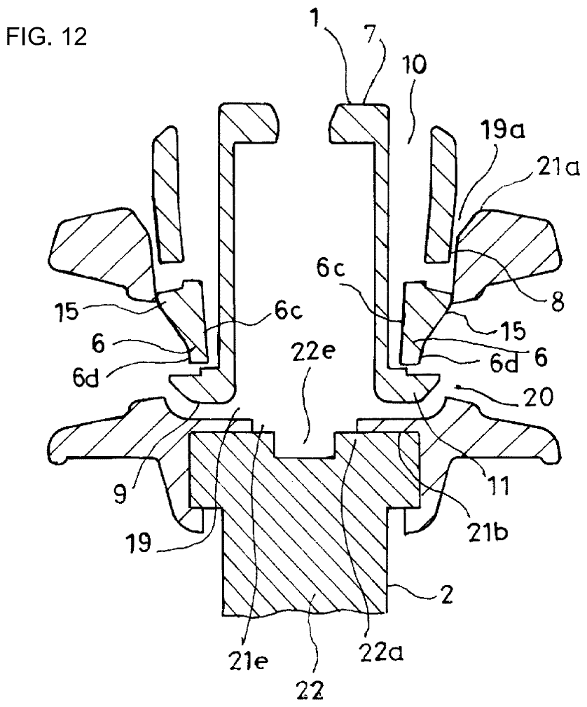

In the example illustrated in the drawings, the shaft-like body 22 has a bolt shape including a flat head 22a (see FIG. 19). The shaft-like body 22 includes a large diameter portion 22b from the flat head 22a to an approximately intermediate position in the length direction and a small diameter portion 22c from the large diameter portion 22b onward. In the outer circumference of this small diameter portion 22c, a male thread 22d is formed. The shaft-like body 22 is integrated with the tubular body 21 in such a manner that the flat head 228 is built inside a portion composing the other tube end 21b of the tubular body 21 and that portions below this flat head 22a, that is, the large diameter portion 22b and the small diameter portion 22c protrude from the tubular body 21. The tubular body 21 and the shaft-like body 22 are integrated with each other in such a manner that the tube axis x2 of the tubular body 21 and the central axis of the shaft-like body 22 are located on the same imaginary straight line. Moreover, in a center of a closed portion of the other tube end 21b, which is the deep portion of the receiving portion 19, of the tubular body 21, a hole 21e allowing a portion of the flat head 22a to face the receiving portion 19 is defined (see FIG. 12). In the flat head 22a located in this hole 21e, a fit-in recess 22e having a shape complementary to the tip shape of a tool, such as a screwdriver, is defined (see FIG. 9). In the example illustrated in the drawings, by making the shaft-like body 22 as an insert of a mold forming the tubular body 21, the shaft-like body 22 and the tubular body 21 are integrated with each other as described above.

In the example illustrated in the drawings, the fastened target 2 uses the male thread 22d of the shaft-like body 22 to screw the shaft-like body 22 into a screw hole 23 of the other target object 3 and can thus be attached to the other target object 3.

FIG. 20 illustrates a state where the fastened target 2 is attached to a side wall of a vehicle interior as the other target object 3. In FIG. 20, reference sign 24 indicates the side wall (trim), and reference sign 25 indicates a body panel. The shaft-like body 22 is screwed into the screw hole 23 defined in the body panel 25 through a through hole defined in the side wall 24.

In the example illustrated in the drawings, for example, in a case where the fastened target 2 is attached to the side wall 24 of the vehicle interior in such a manner that the tubular body 21 protrudes from this side wall 24 toward the vehicle interior, the fastened target 2 allows hanging of a shopping bag handle or the like on the tube side portion 21c between the outer flanges 21d in the two places, and the like, and can be used as a hook, so to speak. The fastened target 2 can also be used, with the fastener 1 detached, to allow a string or the like to pass through the engagement hole 20 defined in the tube side portion 21c or to hang a hanger hook in this engagement hole 20. The fastened target 2 can also be used, with the fastener 1 detached, to receive an end of a bar-like body or the like in the receiving portion 19 to support the bar-like body or the like in the vehicle interior.

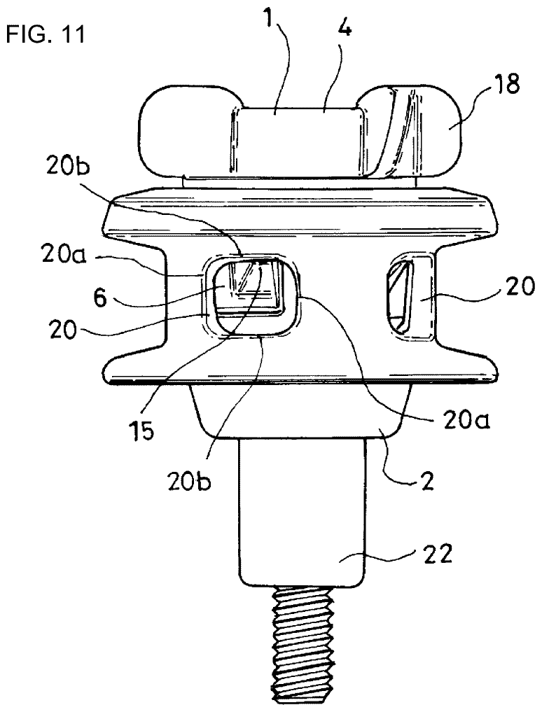

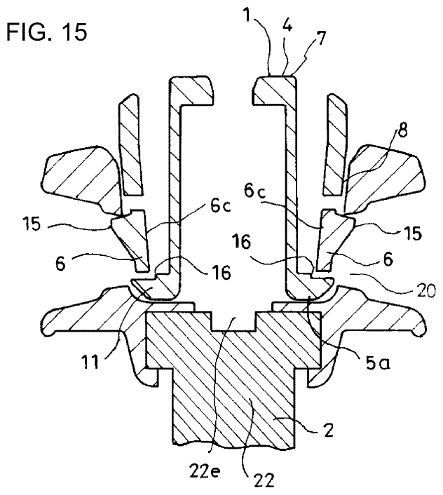

The fastener 1 includes the head portion 4 and the trunk portion 5 having a hollow shaft shape (see FIG. 1) . In the example illustrated in the drawings, while a tip 5a on a side opposite to a place of connection to the head portion 4 in the trunk portion 5 is made the front, the trunk portion 5 can be introduced into the receiving portion 19 of the fastened target 2 until the tip 5a substantially abuts on the closed portion of the other tube end, which is the deep portion of the receiving portion 19, of the tubular body 21 (FIG. 15/a completion position of the introduction). In this completion position of the introduction, the trunk portion 5 enters the receiving portion 19, and the head portion 4 is located outside the receiving portion 19 (see FIG. 11).

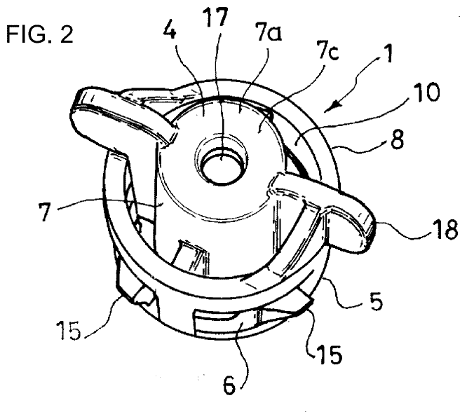

In the example illustrated in the drawings, the fastener 1 includes an inner tube portion 7 and an outer tube portion 8 (see FIG. 2).

The inner tube portion 7 is open at both ends. Furthermore, one end 7a and its vicinity of the inner tube portion 7 compose a portion of the head portion 4. The other end 7b and its vicinity of the inner tube portion 7 compose a portion of the tip 5a of the trunk portion 5.

The inside diameter of the outer tube portion 8 is larger than the outside diameter of the inner tube portion 7. Furthermore, the overall length of the outer tube portion 8 is shorter than the overall length of the inner tube portion 7.

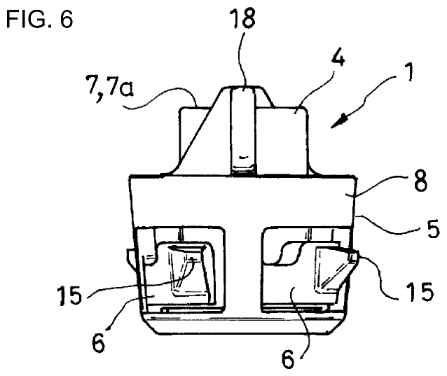

One end 8a, located adjacent to the head portion 4, of the outer tube portion 8 is located closer to the tip 5a of the trunk portion 5 than the one end 7a of the inner tube portion 7, and the one end 7a and its vicinity of the inner tube portion 7 protrude from the one end 8a of the outer tube portion 8 to form the head portion 4 (see FIG. 6).

Furthermore, the inner tube portion 7 and the outer tube portion 8 are integrated with each other using a circular connecting portion 9 extending between the other end 7b of the inner tube portion 7 and the other end 8b of the outer tube portion 8 (see FIG. 1).

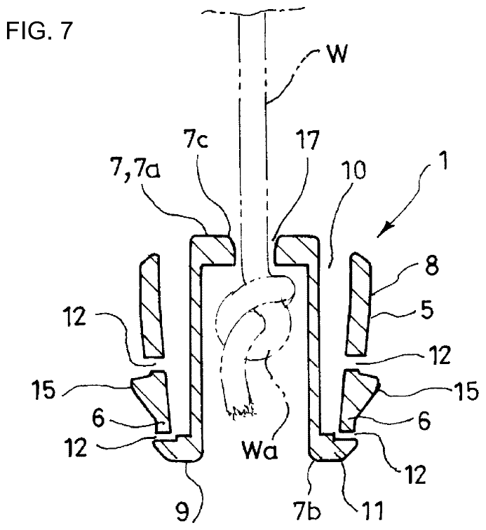

Furthermore, the inner tube portion 7 and the outer tube portion 8 are integrated with each other in such a manner that a gap is defined between the outer surface of the inner tube portion 7 and the inner surface of the outer tube portion 8 in any position in a direction circling around the central axis x1 of the trunk portion 5 (see FIG. 5), that is, the tube axis of the inner tube portion 7. The elastic arm portion 6, described later, uses this gap to elastically deform in a direction toward the central axis x1, described later. Thus, the fastener 1 includes a circular open portion 10 communicating with the gap in a vicinity of the head portion 4 (see FIG. 7). The fastener 1 also includes a bottom portion 11 formed with the circular connecting portion 9 in a vicinity of the tip 5a.

The elastic arm portion 6 is formed along the direction circling around the central axis x1 of the trunk portion 5.

In the example illustrated in the drawings, the elastic arm portion 6 is formed on the outer tube portion 8.

In the example illustrated in the drawings, two or more elastic arm portions 6 are formed at intervals to the elastic arm portions 6 adjacent in the direction circling around the central axis x1 of the trunk portion 5, and, in the example illustrated in the drawings, four elastic arm portions 6 are formed at 90-degree intervals in the circling direction in correspondence to the number and positions of the engagement holes 20 of the fastened target 2.

In the example illustrated in the drawings, each of the four elastic arm portions 6 is configured to have substantially the same dimensions and the same shape as the other elastic arm portions 6.

In the example illustrated in the drawings, this elastic arm portion 6 is composed of a portion of the outer tube portion 8 that is partitioned by a pair of lateral dividing grooves 12 extending along the direction circling around the central axis x1 and a longitudinal dividing groove 13 extending between ends on one side of the pair of lateral dividing grooves 12 in a direction along the central axis x1.

One in the pair of lateral dividing grooves 12 is defined at substantially the same level as the inner surface of the bottom portion 11. The other in the pair of lateral dividing grooves 12 is defined in an approximately intermediate position of the overall length of the inner tube portion 7.

The elastic arm portion 6 thus formed includes a free end 6a located in a vicinity of the longitudinal dividing groove 13, and its opposite position is a base portion 6b (root).

Furthermore, each of the two or more elastic arm portions 6 thus formed is formed in such a manner that the free end 6a of one of the elastic arm portions 6 adjacent in the direction circling around the central axis x1 adjoins the base portion 6b of the other of the adjacent elastic arm portions 6.

That is, each of the elastic arm portions 6 is formed in such a manner that, in a case where the fastener 1 is rotated in one direction with the central axis x1 as the center (for example, in the direction of arrow r1 in FIG. 1), the free end 6a is located on the forward side of this rotation and the base portion 6b is located on the back side in the rotating direction of this rotation.

Note that, in the example illustrated in the drawings, a groove end, located in a vicinity of the base portion 6b of the elastic arm portion 6, of the lateral dividing groove 12 defined in the approximately intermediate position of the overall length of the inner tube portion 7 is bent toward the tip of the trunk portion 5. This bent point 14 causes a portion in the vicinity of the base portion 6b of the elastic arm portion 6 to have a slightly smaller width in the direction along the central axis x1 than the other portion. This facilitates elastic deformation of a portion in a vicinity of the free end 6a in the elastic arm portion 6 in the direction toward the central axis x1 with the portion in the vicinity of the base portion 6b as the center.

Between the base portion 6b and the free end 6a of the elastic arm portion 6, an engagement protruding portion 15 engaging with the engagement hole 20 of the fastened target 2 is formed.

The engagement protruding portion 15 is formed on an outer surface 6d (the outer surface of the outer tube portion 8) of the elastic arm portion 6 that is located back to back with an inner surface 6c (the inner surface of the outer tube portion 8), located to face in the direction of the central axis x1, of the elastic arm portion 6 (see FIG. 12).

In the example illustrated in the drawings, the engagement protruding portion 15 is formed in a region located between a position that is approximately half of the overall length of the elastic arm portion 6 (the length between the base portion 6b and the free end 6a) and the free end 6a (see FIG. 5).

In the example illustrated in the drawings, the engagement protruding portion 15 includes a top portion 15a, a side inclining surface 15b, a lower inclining surface 15c, a side engaging surface 15d, and an upper engaging surface 15e (see the partially enlarged view in FIG. 5).

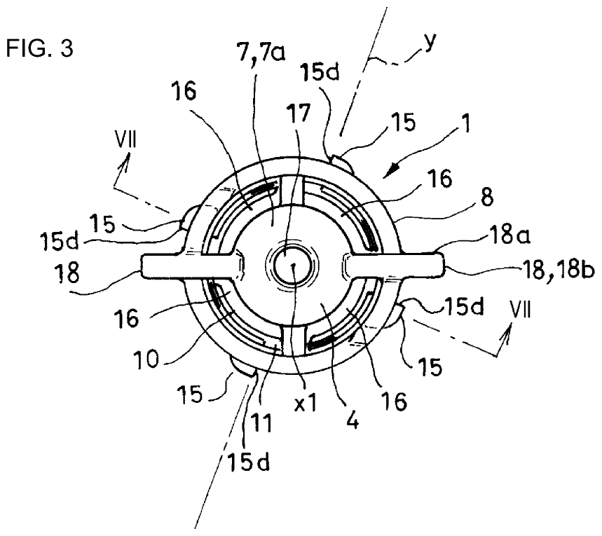

Relative to the top portion 15a, the side inclining surface 15b is formed on the base portion 6b side of the elastic arm portion 6, and the side engaging surface 15d is formed in a position opposite to the side inclining surface 15b. That is, in the direction circling around the central axis x1, the top portion 15a is located between the side inclining surface 15b and the side engaging surface 15d. In the example illustrated in the drawings, the side engaging surface 15d is a surface that is continuous with the free end 6a of the elastic arm portion 6 and that is along an imaginary straight line y (see FIG. 3) orthogonal to the central axis x1 and extending in a radial direction.

Relative to the top portion 158, the lower inclining surface 15c is formed in a direction where the bottom portion 11 is present, and the upper engaging surface 15e is formed in a position opposite to the lower inclining surface 15c. That is, in the direction along the central axis x1, the top portion 15a is located between the upper engaging surface 15e and the lower inclining surface 15c.

The side inclining surface 15b has such a configuration that the height of the engagement protruding portion 15 decreases gradually toward the base portion 6b of the elastic arm portion 6.

Furthermore, the lower inclining surface 15c has such a configuration that the height of the engagement protruding portion 15 decreases gradually from the head portion 4.

The outside diameter of the trunk portion 5 is slightly larger than the entrance 19a of the receiving portion 19 and the inside diameter of the other tube end 21b of the tubular body 21 of the fastened target 2 in a position where the top portion 15a of the engagement protruding portion 15 is formed, The outside diameter of the trunk portion 5 has such a size that the trunk portion 5 can be accommodated in the receiving portion 19, except in a position where the engagement. protruding portion 15 is formed.

Furthermore, when the trunk portion 5 is introduced into the receiving portion 19 up to the completion position of the introduction, the engagement protruding portion 15 is located at a level where the engagement protruding portion 15 can enter the engagement hole 20.

Introduction operation of introducing the trunk portion 5 into the receiving portion 19 is allowed through sliding contact of the engagement protruding portion 15 with the inner surface of the side wall of the receiving portion 19 and accompanying elastic deformation of the elastic arm portion 6 in the direction toward the central axis x1 (see FIGS. 11 and 12). This insertion operation is facilitated by the lower inclining surface 15c. At this time, the elastic arm portion 6 is subjected to force toward a side opposite to the inserting direction and elastically deforms in the direction toward the central axis x1 on a restraining portion 16, described later, without hitting this restraining portion 16.

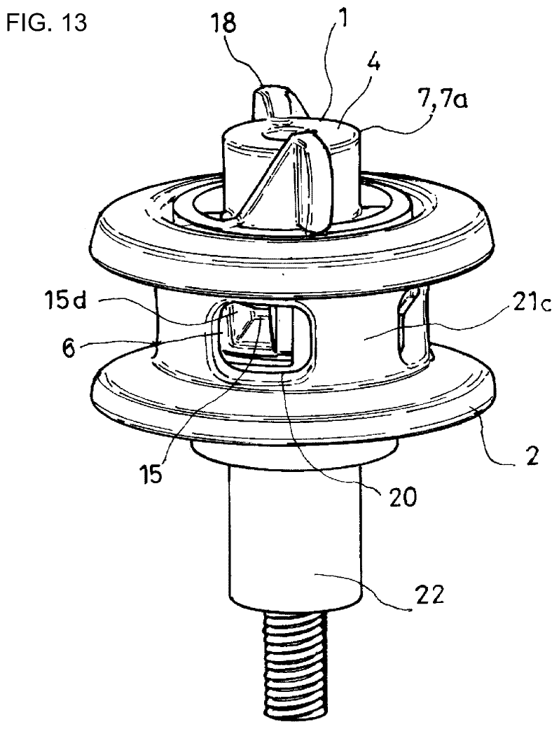

When the trunk portion 5 is introduced into the receiving portion 19 up to the completion position of the introduction and when the engagement protruding portion 15 is located on the interior side of the engagement hole 20, the elastic arm portion 6 elastically returns to allow the engagement protruding portion 15 to enter the engagement hole 20 (see FIGS. 13 to 15).

When the trunk portion 5 is introduced into the receiving portion 19 up to the completion position of the introduction but in such an orientation that the engagement protruding portion 15 is located between the adjacent engagement holes 20, operation of rotating the fastener 1 slightly in the direction circling around the central axis x1 allows the engagement protruding portion 15 to be located on the interior side of the engagement hole 20. With this, similar to the above case, the elastic arm portion 6 elastically returns to allow the engagement protruding portion 15 to enter the engagement hole 20.

This enables the fastener 1 to be fastened to the fastened target 2 with a single touch, so to speak.

The elastic arm portion 6 is formed along the direction circling around the central axis x1 of the trunk portion 5, so that, in a case where the fastener 1 is subjected to force in a direction of removing the trunk portion 5 from the receiving portion 19 in a state where the fastener 1 is fastened to the fastened target 2, the elastic arm portion 6 is difficult to deform in the direction toward the central axis x1, and the engagement protruding portion 15 is caught on the engagement hole 20, preventing removal of the fastener 1.

On the other hand, if the fastener 1 is subjected to torque causing rotation in a direction r2 (see FIG. 1) toward the base portion 6b of the elastic arm portion 6 with the central axis x1 as the center from the state where the fastener 1 is fastened to the fastened target 2, the engagement protruding portion 15 and the hole edge of the engagement hole 20 come into sliding contact with each other, facilitating elastic deformation of the elastic arm portion 6 in the direction toward the central axis x1. This enables the state where the fastener 1 is fastened to the fastened target 2 to be readily released through rotation operation in the direction r2 toward the base portion 6b of the elastic arm portion 6 composing the fastener 1.

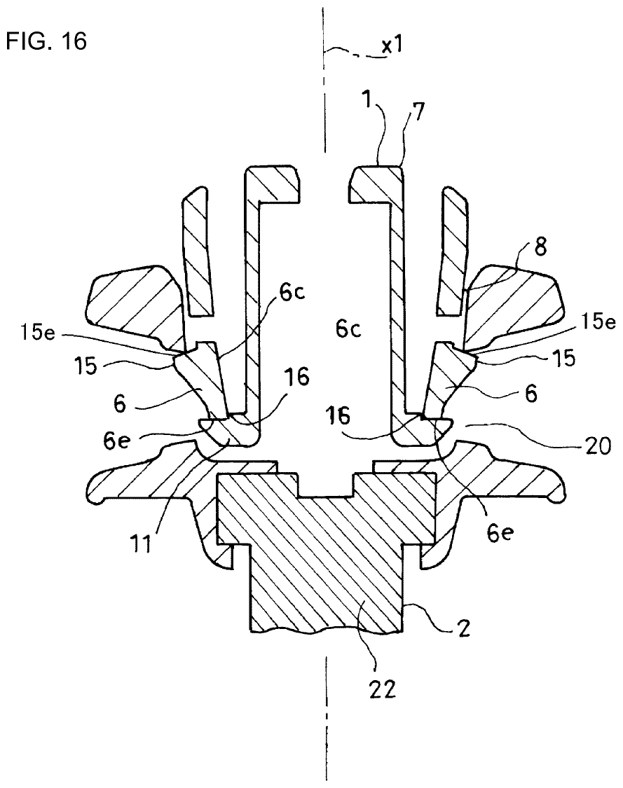

To be more specific, in a case where the fastener 1 is subjected to force in the direction of removing the trunk portion 5 from the receiving portion 19 in the state where the fastener 1 is fastened to the fastened target 2 in this way, the upper engaging surface 15e is caught on the engagement hole 20, preventing removal of the fastener 1 (see FIG. 16).

Furthermore, in a case where the fastener 1 is subjected to torque causing rotation in the direction r1 toward the free end 6a of the elastic arm portion 6 with the central axis x1 as the center from the state where the fastener 1 is fastened to the fastened target 2 in this way, the side engaging surface 15d is caught on the engagement hole 20, preventing removal of the fastener 1.

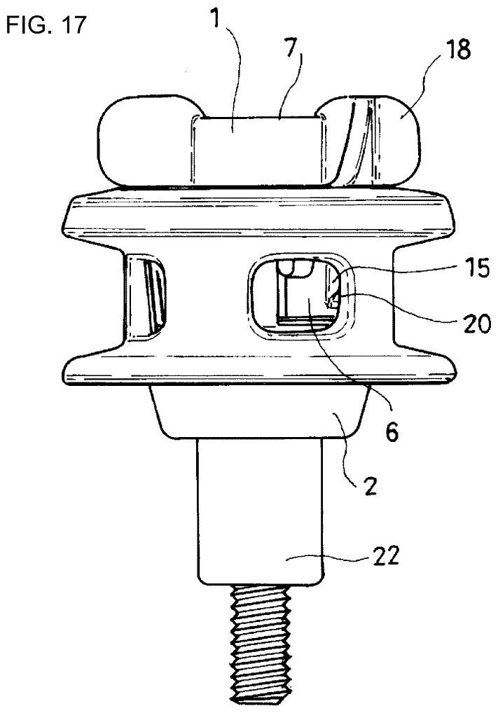

On the other hand, in a case where the fastener 1 is subjected to the torque causing rotation in the direction r2 toward the base portion 6b of the elastic arm portion 6 with the central axis x1 as the center from the state where the fastener 1 is fastened to the fastened target 2 in this way, the side inclining surface 15b and the hole edge of the engagement hole 20 come into sliding contact with each other, causing elastic deformation of the elastic arm portion 6 in the direction toward the central axis x1 (see FIGS. 17 to 19). In this embodiment, this enables the state where the fastener 1 is fastened to the fastened target 2 to be readily released through the rotation operation in the direction r2 toward the base portion 6b of the elastic arm portion 6 composing the fastener 1.

In particular, in the example illustrated in the drawings, the inside diameter of the receiving portion 19 is configured to decrease gradually toward the deep portion of the receiving portion 19, so that, when the engagement protruding portion 15 comes out of the engagement hole 20 through the rotation operation and comes into contact with the inner surface of the receiving portion 19 outside the engagement hole 20, elastic force of the elastic arm portion 6 is applied to the trunk portion 5 as a force in a direction of coming out of the receiving portion 19, and the trunk portion 5 is, so to speak, pushed out of the receiving portion 19 and comes out smoothly.

Note that the rotation operation on the fastener 1 in the direction r1 toward the base portion 6b of the elastic arm portion 6 can be performed continuously by repeating elastic deformation and elastic return of each elastic arm portion 6 (idle turning, so to speak), and the rotation operation in this direction does not cause damage to the fastener 1.

Furthermore, in this embodiment, the trunk portion 5 is provided with the restraining portion 16 that, when the force in the direction of removing the trunk portion 5 from the receiving portion 19 is applied, comes into contact with the elastic arm portion 6 to prevent elastic deformation of the elastic arm portion 6.

In this embodiment, the bottom portion 11 is provided with the restraining portion 16.

When the trunk portion 5 is subjected to force in the removing direction, the upper engaging surface 15e is caught on the engagement hole 20 as described above, and this catching causes the elastic arm portion 6 to be subjected to force deforming this elastic arm portion 6 in the direction toward the central axis x1. In this embodiment, when such force is applied, a thick surface 6e, in a vicinity of the bottom portion 11, of the elastic arm portion 6 abuts on the bottom portion 11, and the protrusion-like restraining portion 16 disposed in a position closer to the central axis x1 relative to the inner surface 6c of the elastic arm portion 6 on the bottom portion 11 abuts on the inner surface 6c of the elastic arm portion 6, preventing deformation of the elastic arm portion 6 in the direction toward the central axis x1 (see FIG. 16). This enables a large setting of resistance to the removal while facilitating releasing of fastening of the fastener 1 through the rotation operation, which stabilizes the fastened state of the fastener 1.

In the example illustrated in the drawings, the fastener 1 further includes a passing hole 17 for a string-like body W that extends across the head portion 4 and the trunk portion 5 (see FIGS. 1, 2, and 17).

In the example illustrated in the drawings, at the one end Za of the inner tube portion 7 composing the head portion 4, an inner flange 7c is formed. The passing hole 17 is defined to extend between this inner flange 7c and the other end 7b of the inner tube portion 7 composing the trunk portion 5 (see FIG. 17).

With this, in the example illustrated in the drawings, by passing the string-like body W through the passing hole 17 from the one end side and then making a knot Wa at an end of the string-like body W to cause the knot Wa to be caught on the inner flange 7c in the inner tube portion 7, the fastener 1 can be practically provided at an end portion of the string-like body W (see FIG. 7). Then, the fastener 1 thus linked to the string-like body W is fastened to the fastened target 2, which enables the string-like body W to be linked to the fastened target 2 via the fastener 1 (see FIG. 20).

In the example illustrated in the drawings, the fastener 1 further includes pinch portions 18 on the head portion 4 (see FIG. 2).

The pinch portions 18 are mainly composed of plate pieces 18a protruding from the side portion of the inner tube portion 7 in a direction orthogonal to the central axis x1 at the one end 7a of the inner tube portion 7 (see FIG. 3). The plate pieces 18a are formed in such a manner that their plate surfaces are aligned with the central axis x1. Furthermore, the plate pieces 18a are formed on both sides in the diameter direction of the inner tube portion 7. Furthermore, protruding ends 18b of the plate pieces 18a are located outward relative to the side portion of the outer tube portion 8, and the plate pieces 18a and the outer tube portion 8 are integrated with each other in a range where the plate pieces 18a are formed.

In the example illustrated in the drawings, this enables the fastener 1 to be fastened to the fastened target 2 by using the pinch portions 18. Furthermore, torque in a direction of releasing this fastening (the torque causing rotation in the direction r2 toward the base portion 6b of the elastic arm portion 6 with the central axis x1 as the center) can be applied to the fastener 1.

Furthermore, from the state where the fastener 1 is fastened to the fastened target 2, the pinch portions 18 can be used to subject the fastener 1 to torque in an opposite direction relative to the torque in the direction of releasing the fastening (the torque causing rotation in the direction r1 toward the free end 6a of the elastic arm portion 6 with the central axis x1 as the center), and, at this time, the fastened target 2 can be rotated simultaneously. In the example illustrated in the drawings, this simultaneous rotation enables releasing of screwing of the male thread 22d of the shaft-like body 22 to, for example, remove the fastened target 2 including the fastener 1, that is, the vehicle interior accessory from the side wall side in the vehicle interior.

Note that, understandably, the present invention is not limited to the embodiment described above and includes all embodiments that can achieve objects of the present invention.

### REFERENCE SIGNS LIST

1 Fastener
2 Fastened target
5 Trunk portion
6 Elastic arm portion
6a Free end
6b Base portion
15 Engagement protruding portion
19 Receiving portion
20 Engagement hole
x1 Central axis

Note that the entire contents of the specification, claims, drawings, and abstract of Japanese Patent Application No. 2022-146755, filed on Sep. 15, 2022, are hereby incorporated by reference as the disclosure of the specification of the present invention.

1. A fastener comprising:
a head portion disposed at one end;
a trunk portion connected to the head portion; and
an elastic arm portion which becomes a portion of the trunk portion,
the fastener allowing introduction of the trunk portion into a receiving portion configured to be defined in a fastened target through elastic deformation of the elastic arm portion toward a center of the trunk portion,
the fastener being configured to be fastened to the fastened target by causing a portion of the elastic arm portion to enter an engagement hole defined in a side wall of the receiving portion through elastic return of the elastic arm portion in a completion position of the introduction,
wherein
the elastic arm portion is formed along a direction circling around a central axis of the trunk portion, and
an engagement protruding portion engaging with the engagement hole is formed between a base portion and a free end of the elastic arm portion.

2. The fastener according to claim 1, wherein the elastic arm portion is two or more elastic arm portions formed on the trunk portion at intervals in the direction circling around the central axis, and the two or more elastic arm portions are formed in such a manner that the free end of one of the elastic arm portions adjacent in the circling direction adjoins the base portion of another of the adjacent elastic arm portions.

3. The fastener according to claim 1, wherein the trunk portion is provided with a restraining portion preventing elastic deformation of the elastic arm portion by contacting with the elastic arm portion when a force in a direction of removing the trunk portion from the receiving portion is applied.

4. The fastener according to claim 3, wherein
the trunk portion includes a bottom portion, the elastic arm portion being located between the bottom portion and the head portion, and
the bottom portion is provided with the restraining portion.

5. The fastener according to claim 1, wherein the engagement protruding portion includes a side inclining surface decreasing a height of the engagement protruding portion gradually as the engagement protruding portion approaches the base portion of the elastic arm portion.

6. The fastener according to claim 1, wherein the engagement protruding portion includes a lower inclining surface decreasing a height of the engagement protruding portion gradually as the engagement protruding portion leaves from the head portion.

7. The fastener according to claim 1, further comprising a passing hole for a string-like body, the passing hole extending across the head portion and the trunk portion.

8. The fastener according to claim 1, wherein the head portion includes a pinch portion.

9. A fastening structure comprising:
the fastener according to claim 1; and
the fastened target including the receiving portion for the trunk portion of the fastener,
wherein an inside diameter of the receiving portion decreases gradually toward a deep portion of the receiving portion.

10. A vehicle interior accessory comprising:
the fastener according to claim 1; and
the fastened target including the receiving portion for the trunk portion of the fastener,
wherein the fastened target is a tubular body including the engagement hole in a tube side portion between one tube end and another tube end, the one tube end being an entrance of the receiving portion and being open.
